(19) United States
(12) Patent Application Publication
(10) Pub. No.: US 2025/0102691 A1
(43) Pub. Date: Mar. 27, 2025

(54) MARINE SEISMIC ACQUISITION SYSTEM AND RELATED APPARATUS

(71) Applicant: AKITEMOS SOLUTIONS, LLC, Hollywood, FL (US)

(72) Inventor: Stig Rune Lennart TENGHAMN, Hollywood, FL (US)

(73) Assignee: Akitemos Solutions AB, Jönköping (SE)

(21) Appl. No.: 18/729,823

(22) PCT Filed: Feb. 8, 2023
(86) PCT No.: PCT/US2023/012596

§ 371 Date: Jul. 17, 2024

Related U.S. Application Data
(60) Provisional application No. 63/267,749, filed on Feb. 9, 2022.

(51) Int. Cl. G01V 1/145; G01V 1/38

(52) U.S. Cl. CPC G01V 1/145; G01V 1/3808; G01V 2210/1293

(57) ABSTRACT

A marine seismic acquisition method capable of obtaining low frequency marine seismic data. The method can employ a dipole capable of reducing interference from waves reflected from the surface of a body of water for low frequency subsurface measurements. The dipole can be deployed from a surface vessel with a plate, drivers, and springs to generate a low frequency resonance.

### FIELD OF THE TECHNOLOGY

This disclosure generally relates to the field of seismic imaging. More particularly, this disclosure relates to the acquisition of low frequency seismic data and a marine seismic source capable of providing low frequency seismic waves which is for example an important part of full waveform inversion.

### BACKGROUND

Seismic imaging is the process of mapping subsurface formations with noninvasive techniques. Marine seismic measurement systems typically employ a seismic acquisition system to acquire seismic data. The seismic acquisition system includes a source, which initiates a seismic wave, sensors, which detect the seismic wave, and other components. The seismic wave propagates from the source through the water and subsurface where it illuminates subsea geologic formations. As it illuminates interfaces or boundaries, part of the seismic wave is returned or reflected through the earth in the up-going direction as a primary reflection. A portion of this reflected seismic wave is detected by the sensors of the seismic acquisition system, converted into electrical signals, and recorded as seismic data for subsequent processing. An analysis of these recorded data or signals makes it possible to estimate the structure, position, impedance, fluid type, and lithology of subsea geologic formations, among other parameters, thereby completing an important step in the interpretation process.

One method of seismic imaging can be through the use of low frequency pressure waves. Pressure waves can travel through water and subsurface formations. Higher frequency pressure waves may be attenuated more rapidly than lower frequency pressure waves, and consequently, lower frequency pressure waves can be transmitted over longer distances through water and geological structures than higher frequency pressure waves. In addition, the lowest frequency range can be important for deriving the elastic properties of the subsurface by seismic full wave field inversion (FWI). Accordingly, there has been a need for powerful low frequency marine sound sources operating in the frequency band of 1 Hz to 100 Hz and, as low as 2 to 3 octaves below 6 Hz.

However, generation of low frequency pressure wave fields from seismic sources based on volume injection, such as air guns, marine vibrators, benders, etc., hereinafter referred to as “monopole-type sources,” may be limited by a ghost function of the monopole-type source. This can be a circumstance in which the pressure wave fields that propagate toward the water surface are reflected at the water-air interface. These reflected waves, commonly referred to as “ghosts,” have the opposite polarity of the up-going waves and propagate toward the water bottom. The ghosts interfere with the pressure waves from the sound source going downwards toward the bottom and act as a filter on the reflected wave field. These conventional solutions to have not been wholly satisfactory, in part due to the ghosts interfering with measurements. Thus, there is room for improvement in the art.

### SUMMARY

A first embodiment of the present technology provides for a marine dipole source. The dipole source can include a moveable plate connected to a surface vessel by a deployable structure. The source can further include one or more driver and one or more spring elements connected to the moveable plate to produce a resonance.

In some embodiments, the drivers can use linear motors. The spring elements may be adjustable to a specific frequency band of interest. In deployable structure may position the plate between 1-10 meters below the sea surface and can have a streamlined form to reduce drag.

In embodiments, the moveable plate can vibrate at a frequency from 0.1-25 Hz. The marine dipole can also have a control system for controlling the frequency of the drivers and spring elements.

A second embodiment of the present technology provides for a method of seismic surveying for undersea formations. The method can include connecting a seismic dipole source to a surface vessel and moving the surface vessel through a body of water over an undersea formation. The seismic dipole source can generate low frequency signals which can be reflected by the undersea formation and received by a plurality of sensor streamers.

In some embodiments, the signals can be generated by moving a sound emitting surface with linear motors and spring elements. This can generate a plurality of up-going waves and first down-going waves. The up-going waves can reflect off a surface of the body of water. This can result in a series of second down-going waves. The second down-going waves can combine, in phase, with the first down-going waves to produce a third down-going wave.

A third embodiment of the present technology provides for a marine surveying system. The system can include a moveable surface vessel, a marine dipole source connected to the vessel, a control system for the source on the vessel, and at least one sensor. The marine dipole can be positioned 1-10 meters below the moveable surface vessel and can be controlled by the control system to operate at frequencies between 0.5 and 10 Hz.

In some embodiments, the system can further comprise streamers spaced laterally apart from each other behind the vessel. The streamers can include at least one sensor and generate response signals from the acoustic energy emitted from the dipole source after interaction with the subsurface formations. Alternatively, the sensors can be positioned on a solid marine surface. The vessel may also be autonomous in some embodiments.

### BRIEF DESCRIPTION OF THE DRAWINGS

In order that the way the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail using the accompanying drawings in which:

FIG. 1 shows an ocean streamer cable marine seismic acquisition system.

FIG. 2 shows an ocean bottom node (“OBN”) marine seismic acquisition system.

FIG. 3 shows a distributed acoustic sensing (“DAS”) marine acquisition system.

FIG. 4 shows an autonomous source vessel with marine vibrators.

FIG. 5 shows the installation of the low frequency source on a catamaran vessel.

FIG. 6 shows additional detail of the low frequency source of FIG. 5.

FIG. 7 shows a cross-sectional view of the low frequency source.

FIG. 8 shows the low frequency source with an additional cone shaped surface.

FIG. 9 shows stacked double low frequency sources.

FIG. 10 shows adjacent double low frequency sources.

FIG. 11 shows the installation of the low frequency source on a catamaran together with marine vibrators.

FIG. 12A shows two finite element simulations of the low frequency source.

FIG. 12B depicts a low frequency source simulation at a depth of 1 meter.

FIG. 12C depicts a low frequency source simulation at a depth of 5 meters.

FIG. 13 shows the attenuation due to the source ghost.

FIG. 14 shows the frequency response of a geophone.

FIG. 15 shows a comparison between a hydrophone and a geophone.

### DETAILED DESCRIPTION

The foregoing has outlined rather broadly the features of the present disclosure in order that the detailed description that follows may be better understood. Additional features and advantages of the disclosure will be described hereinafter, which form the subject of the claims.

The particulars shown herein are by way of example and for purposes of illustrative discussion of the embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice. The described sources can be used for conventional exploration but are of special interest in using marine vibrators for so called 4D work, as they are more repeatable than conventional air guns. Four-dimensional (4D) or so-called time-lapse seismic data is created by three-dimensional (3D) seismic data acquired at different times over the same area to assess changes in a producing hydrocarbon reservoir with time. Changes may be observed in fluid location, saturation, pressure, and temperature. 4D seismic data is one of several forms of time-lapse seismic data. Such data can be acquired on the surface, on the seafloor, or in a borehole.

The technology can also be used for geological CO2 storage. Before and during the injection phase of a CO2 storage formation, a comprehensive monitoring program should be established. In the early post-injection phase, most of the monitoring activities will be performed. Several 4D seismic surveys can be acquired for characterizing the reservoir structure and its overburden and for monitoring the propagation of the injected CO2 in the storage formation. Receivers can either be towed streamers, nodes on the seafloor, permanently installed receivers on the seafloor, or distributed acoustic sensing (sensors used by fiber, so called DAS) in the existing boreholes.

A reflection off the ocean surface can give rise to what is called a “ghost.” When an isotropic source is fired, a down going ‘source ghost’ combines with the wave initially radiated in the down-going direction. This combination of two down-going waves modulates the source's amplitude spectrum by the amplitude of a sine function and results in the attenuation of low frequencies for the combined down-going wave and a reduction in the amount of information available in the seismic data. This loss of low frequencies is observed in a measurement of the combined wave's pressure and its particle motion. This disclosure describes sources such that the combined down-going wave may not have its amplitude spectrum modulated in this way. Instead, the source can modulate the source's amplitude spectrum by the amplitude of a cosine function to enhance the acquisition of low frequency seismic data. Recorded seismic data can also include a ‘sensor ghost’.

In the sensor's case, an up-going wave reflects off the ocean surface and gives rise to a down-going sensor ghost. The sensor can measure the combined up-going wave and down going sensor ghost. This contrasts with the source's case, which is a combination of two down-going waves. As an example, in a one-dimensional ocean bottom node (OBN) case, a sensor ghost can be reflected of the surface and delayed by the two-way travel time in the water column. The sensor ghost can have the same effect on a pressure measurement as observed before the source ghost because pressure is a scalar quantity, and it is not sensitive to direction. This means that a measurement of the low frequencies associated with the combined wave's pressure may be attenuated in a similar way as they would be for the source case. However, motion is a vector quantity sensitive to direction and the measurement of the combined wave's motion can exhibit different behavior from that associated with the combined wave's pressure. The low frequencies associated with the combined wave's motion may be retained and enhanced. In theory this would mean that a motion sensor would be preferred. Since most motion sensors are based on a mass spring system the sensitivity will change with frequency. At 0 Hz the sensitivity is null. It then improves depending on where the resonance of the sensor is located. Results from using a pressure sensor or a motion sensor can be similar.

Mathematically, the amplitude spectrum associated with the combined wave is modulated by the amplitude of a sine or cosine function depending on whether the wave's pressure or motion, respectively, is being measured. When low frequencies are not available in the seismic data, impedance estimates for the subsurface derived from the seismic data may not contain low frequency information. Without low frequency information, unique solutions for impedance are not available. This hampers interpretation of the derived impedance because many unconstrained solutions are possible. Some of the impedance solutions might accurately describe the earth's impedance and others will not. If the low frequencies are retained, additional information can be incorporated into the impedance solution to reduce the non-uniqueness and to restrict attention to only the most geo-physically plausible structures.

The sensors used in typical marine seismic surveying include pressure sensors and/or motion sensors, (e.g., displacement, velocity, acceleration, or higher temporal derivatives of displacement). Typically, pressure sensors can be hydrophones and motion sensors can be geophones that usually measure particle velocity or acceleration. Hydrophones measure a scalar pressure and are not sensitive to the propagation direction of a seismic wave. Geophones, which might be vertically oriented, provide a measurement in the direction of orientation whose polarity depends on whether the direction of propagation is up-going or down-going. The amplitude of a geophone response can also be related to the angle of the propagation relative to the sensitive direction of a geophone. If a seismic wave is recorded by a hydrophone and a vertically oriented geophone that have identical impulse responses, then a polarity comparison between the hydrophone and geophone recordings can determine whether the wave is propagating in the up-going or down going direction. Hydrophones and geophones are typically used in pairs when collecting seismic data. The sensors can be located at somewhat regular intervals in node pattern and are typically deployed along the seafloor. OBN arrangements are particularly well suited for use in certain zones (such as zones cluttered with platforms or where the water is very shallow) and where the use of ship-towed hydrophone arrays (which are located proximate the ocean surface and are typically referred to as “streamers”) are not practical. A combination of separate ocean bottom nodes and streamer cables can also be deployed.

A major source of the lack of low frequency content in seismic data resides with the seismic acquisition system. A monopole marine source array radiates a wave having frequency spectrum A(f). The ocean surface creates a reflection (or ghost) with frequency spectrum −A(f) that combines with the original down-going wave having the frequency spectrum A(f). The composite down-going wave (down-going plus the ocean surface reflected wave) has an amplitude spectrum with attenuated low frequencies because of destructive interference at the low frequencies. The source's amplitude spectrum will be attenuated by the amplitude of a sine function. The lack of low frequency content in the seismic wave is compounded when the up-coming reflections from the sub-surface are recorded by a hydrophone on the surface of the seafloor.

Hydrophone measurements are subjected to a sensor ghost that modulates the amplitude spectrum by the amplitude of a sine function, which attenuates the low frequencies. Geophone measurements are subjected to a sensor ghost that modulates the amplitude spectrum by the amplitude of a cosine function.

Even when data is recorded by a geophone on an Ocean Bottom Node (OBN), modern OBN acquisition techniques still normally use a source that lacks low frequency content. As described above, a principal problem in the recovery of impedance from seismograms is this lack of low frequencies in the seismic data. Accordingly, there is a need for a method and apparatus which generates low frequencies which can be measured in the seismic data. Aspects of this disclosure are directed to these needs.

An example of this disclosure is a marine seismic acquisition system and source driver apparatus. More specifically, the system of this disclosure can provide seismic waves containing larger frequency bandwidths (including low frequencies) than prior art methods, thereby leading to a better reflectivity estimate and an improved impedance estimate. Furthermore, with the present disclosure, improved temporal and spatial resolution can be obtained after inversion.

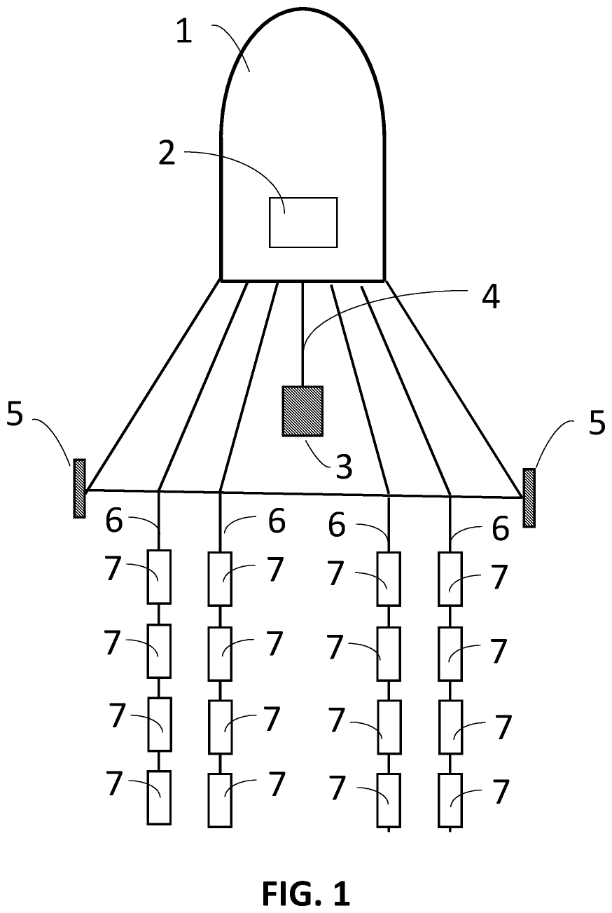

Embodiments of this disclosure provide the ability to retain low frequencies in the wave radiated by the source and requires a sensor to measure or record the pressure or the motion created by the seismic wave. The motion sensor could be a geophone on the ocean floor or some other type of motion sensor that directly measures motion in the water column. Alternatively, motion sensors might measure displacement, velocity, or acceleration (or even higher time derivatives of displacement) either on the ocean floor or in the water column. A motion sensor might utilize the Doppler shift to measure motion created by the seismic wave or might measure the gradient of pressure and take advantage of the fact that the gradient of the pressure can be related to motion. Persons skilled in the art, based on the disclosure contained herein, could deploy a conventional marine streamer (as shown in FIG. 1) adapted to deploy motion sensors capable of detecting motion in the water. These types of streamers exist and deploy either geophones or accelerometer to measure motion. Due to the nature of towing a streamer through water the vibrations make it difficult to measure motion for the low frequency. The method normally uses the pressure sensor at the low frequencies to calculate the corresponding particle velocity. Due to the ghost the pressure sensor will have its limitation in the low part of the frequency spectrum has been discussed. This acquisition system can include low frequency sources in combination with the standard frequency sources to obtain seismic data over a larger frequency band. If hydrophones are used as the sensors, at least one cable should be towed deep to improve the low frequency content. Towing the cable deep would move the ghost notch towards the low end of the frequency spectrum. Having motion sensors in the cable as well would make it possible to eliminate the notches that would appear in the seismic band.

FIG. 1 shows a conventional type of marine seismic surveying with ship 1 towing a seismic source 3 and a plurality of marine streamers 6. Onboard can be a recording unit 2. The source can normally be connected to a gun umbilical 4. A marine cable or streamer 6 incorporating pressure sensing hydrophones 7 can be designed for continuous towing through the water. A marine streamer 6 might be made up of a plurality of active or live hydrophone arrays 7 separated by spacer or dead sections. Usually, the streamers 6 can be nearly neutrally buoyant and depth controllers or depressors can be attached to depress the streamer to the proper towing depth. A tail buoy with a radar reflector can be attached to the end of the streamer 6. The streamers 6 may be 3-15 km in length and may be towed by a ship 1. To keep the streamers 6 separated from each other, deflectors 5 can be used on each side of the streamers 6.

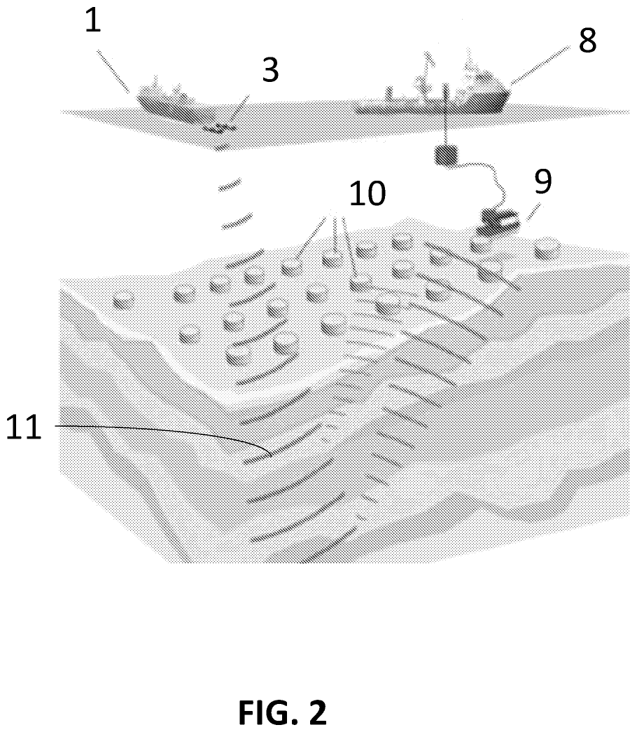

FIG. 2 shows a simplified example of an alternative marine seismic acquisition system. A ship 1 can tow a seismic source 3 several meters below the surface of the ocean. The seismic source 3 can be activated to produce a down-going seismic wave 11 that is at least partially reflected by a subsea interface or boundary. The up-going reflected seismic wave then travels toward the sensors 10 and can be measured. The support vessel 8 is shown using a remotely operated vehicle (“ROV”) 9 to place and retrieve the nodes 10 on the seafloor.

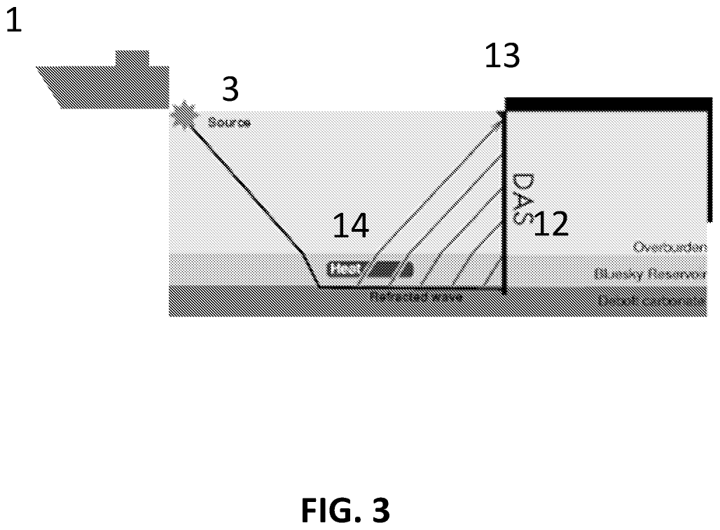

FIG. 3 shows a simplified example of a typical marine seismic acquisition system. A ship 1 can tow a seismic source 3 several meters below the surface of the ocean. The seismic source 3 can then be activated to produce a down-going seismic wave that is at least partially reflected by a subsea interface or boundary 14. The up-going reflected seismic wave then travels toward the sensor cable 12 and can be measured.

The sensors used can be distributed acoustic sensors (“DAS”) 12 deployed in the borehole 13. DAS technology can then measure the particle velocity from the reflected wave. DAS technologies are now becoming widespread, particularly in vertical seismic profiling (“VSP”). Being a spatially densely sampled recording of the seismic wavefield, DAS data provides an extended measurement compared with point geophone VSP.

The measurement uses up- and down-going DAS 12 wavefields. Hydrophones measure a scalar pressure and may not be sensitive to the propagation direction of a seismic wave. Geophones, which might be vertically oriented, can provide a measurement in the direction of orientation whose polarity depends on whether the direction of propagation is up-going or down-going. A combination of separate DAS 12 and streamer cables 6 can be deployed.

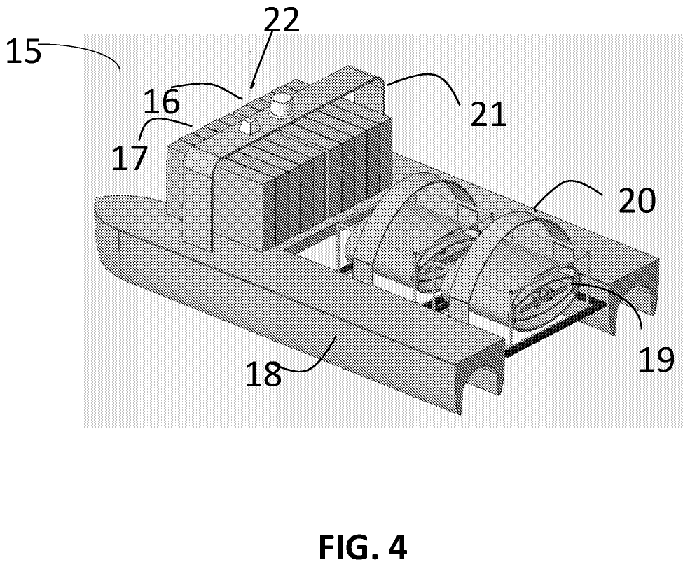

FIG. 4 shows an autonomous source vessel 15 with marine vibrators 19. The autonomous source vessel 15 can be used when a survey using nodes or DAS 12 are used. Normally the sources used can be limited in frequency content. In this particular case two types of sources 19 are shown as being used. One can operate from 5-25 Hz and the second can operate from 25-100 Hz. They can be selected to be used at different depth to make positive use of the surface ghost. The low frequency source can be towed at a depth of approximately 30 m, and the high frequency source can be towed at a depth of approximately 8 m. There may still be a lack of frequencies below 5 Hz. The source vessel can easily be combined with the proposed low frequency source and thereby having a source operating from 1-100 Hz.

If the sources are made with high efficiency, it could also be possible to use an autonomous surface vessel 15. The autonomous source vessel 15 could be made to operate for a couple of weeks in a survey without refueling. This would not only reduce the acoustic footprint but reduce any health, safety, and environmental (“HSE”) risks that exist in a normal survey operation. The autonomous source vessel 15 can have a frame 21 with antenna 22 for remote operations. In the front of the autonomous source vessel 15 there can be a power supply 16 and control system 17 for the marine sources 19 and the operation of the autonomous source vessel 15. For handling of the sources 19 there can be frames 20 which is used to deploy the sources 19. The hull 18 can be used as fuel storage for the autonomous source vessel 15.

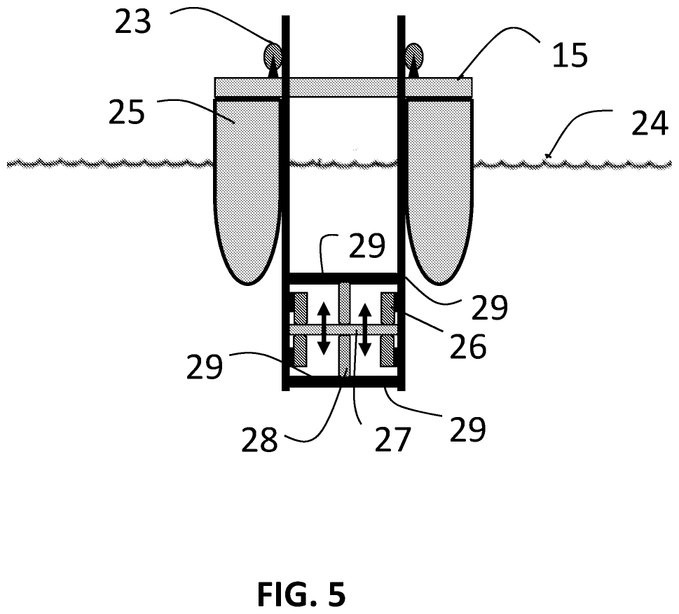

FIG. 5 shows the installation of the low frequency source on a vessel 15. A vessel 15 can have an open space in the middle of the deck with its hulls 25 on each side which makes it suitable to deploy the source at a defined depth below the water 24. Having a dipole source can normally create a problem in having a fixed reference point. Having, for example, a dipole source hanging freely in the water column could be problematic since the up and down going movement needs to be fixed to some structure. There have been suggestions to have a source in a box like arrangement with an excentre inside and a moving mass to generate the up- and down-movement. In at least one example of this disclosure, a surface vessel 15 can be rigidly attached to the source with a fixed structure 29. At least one example includes a vessel 15 with a structure 29 that can be moved up and down into the water by a handling system 23 attached to the structure 29. The source can then be attached to the structure 29 and can be lowered to a predetermined depth of 1-5 m. The source itself may be attached to the structure 29. The source can include a plate 27 with a certain surface area. The plate can then be moved up and down with the help of linear motors 26 or other devices to generate the force needed. The plate 27 is, for example, moved up and down +/−0.1-0.3 m.

If the source has no resonance in the frequency band of interest the efficiency would be very low. This can require introduction of additional energy into the source to generate a small amount of energy into the water column. To understand the importance of resonances for an acoustic source which have a size that is much smaller than the wavelength generated we have the following equation:

$${Z}_{r} = {R}_{r} + j {X}_{r}$$

Where
Zᵣ is total impedance
Rᵣ is radiation impedance, and
jXᵣ is reactive impedance

In an analysis of the energy transfer of a marine vibrator, the system may be approximated as a baffled piston. In the expression of the total impedance that will be experienced, the radiation impedance Rᵣ of a baffled piston is:
Rᵣ=πa²ρ₀cR₁(x) and the reactive impedance is:

$${X}_{r} = π {a}^{2} {ρ}_{0} {cX}_{1} ( x )$$

Where

$$x = 2 ka = \frac{4 π a}{λ} = \frac{2 ω a}{c}$$

and where

$${R}_{1} ( x ) = 1 - \frac{2}{χ} {J}_{1} ( x )$$

$${X}_{1} ( x ) = \frac{4}{π} {\int }_{0}^{\frac{π}{2}} sin ( x cos α ) {sin}^{2} α d α$$

Where
ρ₀=density of water, ω=radial frequency, k=wave number, a=radius of piston, C=sound velocity, λ=wavelength, and J1=Bessel function of the first order. Using the Taylor series expansion on the above equations yields

$${R}_{1} ( x ) = \frac{{x}^{2}}{{2}^{2} 1 ! 2 !} - \frac{{x}^{4}}{{2}^{4} 2 ! 3 !} + …$$

$${X}_{1} ( x ) = \frac{4}{π} [ \frac{x}{3} - \frac{{x}^{3}}{{3}^{2} 5} + \frac{{x}^{5}}{{3}^{2} {5}^{2} 7} - … ]$$

For low frequencies, when x=2ka is much smaller than 1, the real and imaginary part of the total impedance expression may be approximated with the first term of the Taylor expansion. The expressions for low frequencies, when the wavelength is much larger than the radius of the piston, becomes:

$${R}_{1} ( x ) \to \frac{1}{2} {( ka )}^{2}$$

$${X}_{1} ( x ) \to \frac{8 ka}{3 π}$$

It follows that for low frequencies R will be a small number compared to X, which suggests a very low efficiency signal generation. However, by introducing a resonance in the lower end of the frequency spectrum, low frequency acoustic energy may be generated more efficiently. At resonance the imaginary (reactive) part of the impedance is cancelled, and the acoustic source can efficiently transmit acoustic energy into the water.

By introducing spring elements 28 to the sound emitting surface 27, the efficiency of the sound wave generated can be improved. The sound emitting surface 27 will have a resonance which depends on the equivalent water mass acting on the surface, which is the amount of water oscillating with the vibrating sound emitting surfaces and the stiffness of the spring elements K_{Spring}.

For a piston with a radius aₓ the equivalent water mass is

$${M}_{x} = ρ \frac{8 {a}_{x}^{3}}{3}$$

Where ρ is the density. The surface area can be approximated by calculating the length and the width of the plate:

Sₓ=length*width

The equivalent radius aₓ is then arrived from

$${a}_{x} = \sqrt{{S}_{x} / π}$$

The resonance frequency will then be

$$f = \frac{1}{2 π} \sqrt{\frac{{K}_{Spring}}{{M}_{x}}}$$

Having a source operating from 1-10 Hz means that we can either select the resonance to be any of these frequencies. Another possibility would be to have a variable spring constant in the spring element. In the case we run a sweep from 1-10 Hz the spring constant can be adjusted accordingly to create a resonance from 1-10 Hz along the sweep generated. In this case the efficiency of the source would improve considerably.

The source plate 27 can be attached to the structure 29 with, for example, linear bearings. The linear motors 26 and spring elements 28 can be fixed to the structure 29 with the moving part fixed to the source plate 27. The linear motors 26 and spring elements 28 would be protected in a housing with a rubber seal around the moving part attached to the source plate 27.

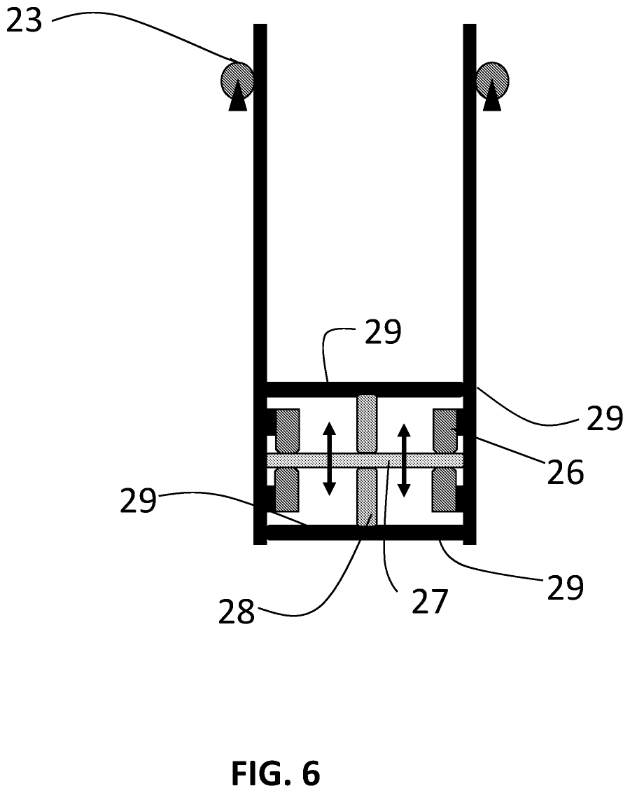

FIG. 6 shows additional details of the low frequency source. The structure 29 can be connected to the surface vessel and can deploy the source at a depth of 1-10 meters below the sea floor. The plate 27 that is put in vibration can be connected to linear motors 26. To generate resonances in the frequency range of interest, spring elements 28 can be attached to the plate 27 and put in vibration by the linear motors 26. On the surface vessel there is an arrangement 23 to deploy the source to various depth. Normal depth would be from 1-10 meters.

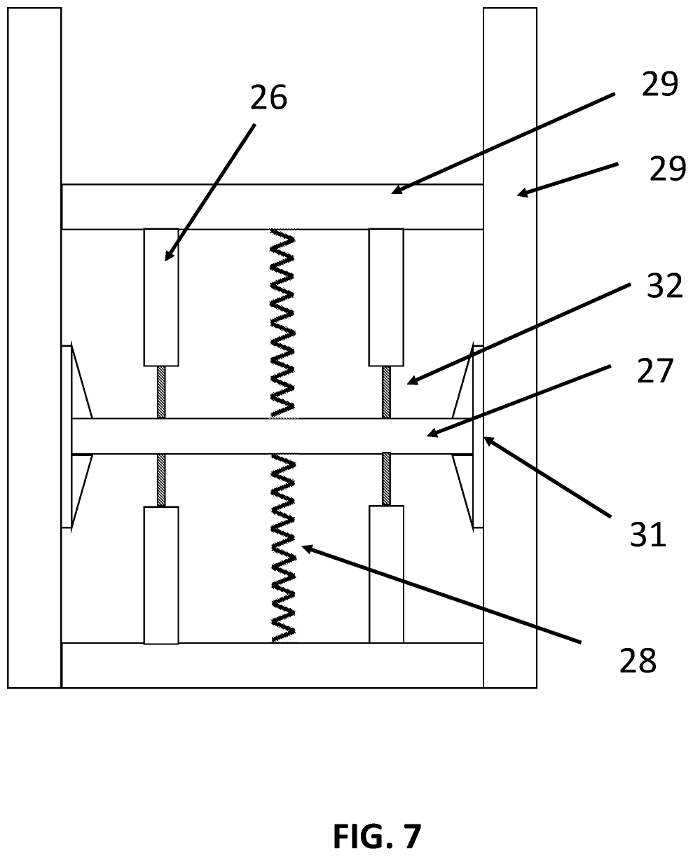

FIG. 7 shows additional details of the low frequency source where the source is connected to a structure 29. To make the plate 27 move up and down in a well-defined movement, bearings 31 can be attached to the structure 29 to reduce the friction between the oscillating plate 27 and the structure 29. The moving rod 32 in the linear motor 26 can be attached to the moving plate 27. To create the resonance, two spring elements 28 can be attached between the plate 27 and the structure 29.

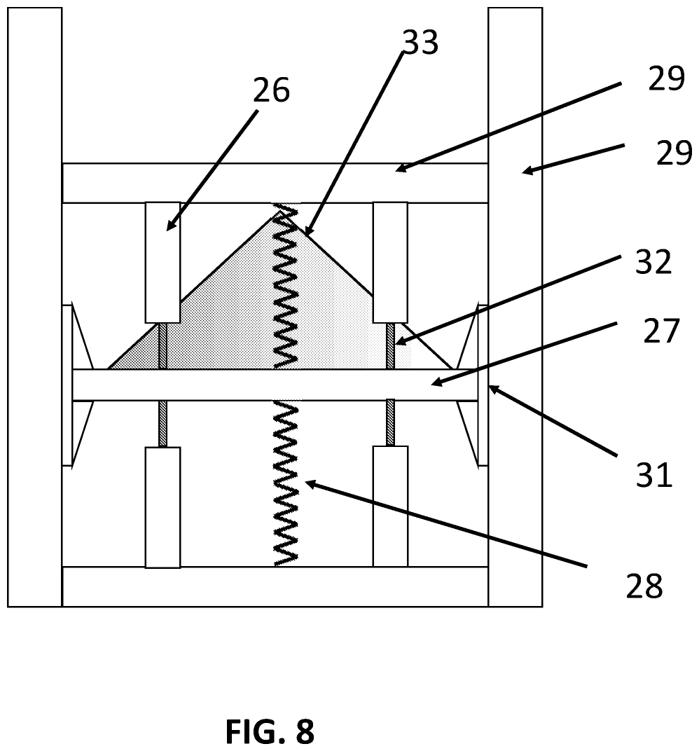

FIG. 8 shows an alternative embodiment of the low frequency source plate 27. The source is connected to a structure 29. To make the source plate 27 move up and down in a well-defined position, bearings 31 can be attached to the structure 29 to reduce the friction between the oscillating plate 27 and the structure 29. The moving rod 32 in the linear motor 26 can be attached to the moving plate 27. To create the resonance, two spring elements 28 can be attached between the plate 27 and the structure 29. The plate 27 can have many different shapes. In the embodiment, the plate 27 have a cone shaped surface 33.

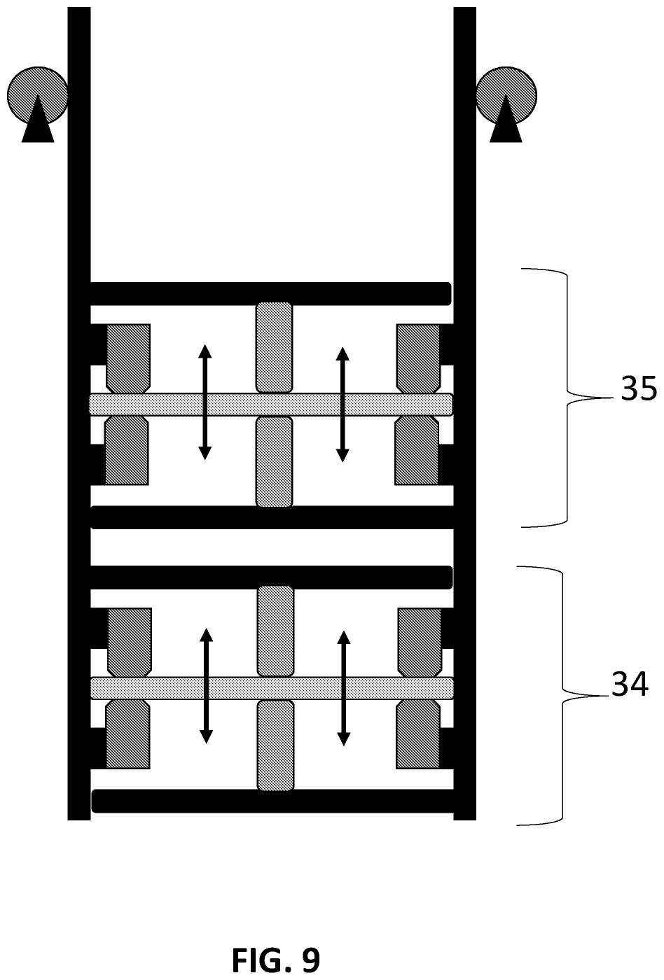

FIG. 9 shows two source 34 and 35. The sources can be connected to a structure 29. To make the plate 27 move up and down in a well-defined position, bearings 31 can be attached to the structure 29 to reduce the friction between the oscillating plate 27 and the structure 29. The moving rod 32 in the linear motor 26 can be attached to the moving plate 27. To create the resonance, two spring elements 28 can be attached between the plate 27 and the structure 29. The sources 34 and 35 can be placed vertically with a distance of a few meters. The sources 34 and 35 can be operated in phase or out of phase. When the sources 34 and 35 are operated in phase the sources 34 and 35 can act as a moving box like source.

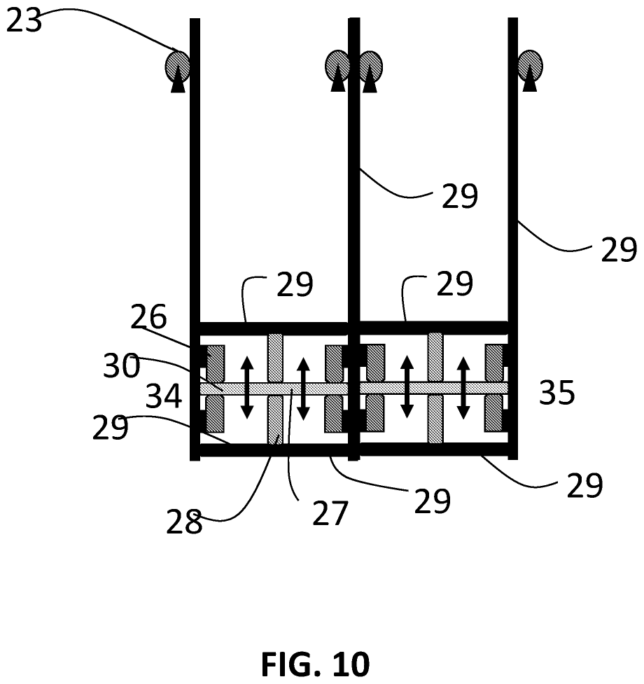

FIG. 10 shows two source 34 and 35 in an alternate arrangement. The sources 34 and 35 can be connected to a structure 29. To make the plate 27 move up and down in a well-defined position, bearings 31 can be attached to the structure 29 to reduce the friction between the oscillating plate 27 and the structure 29. The moving rod 32 in the linear motor 26 can be attached to the moving plate 27. To create the resonance, two spring elements 28 can be attached between the plate 27 and the structure 29. The sources 34 and 35 can be placed side by side horizontally with no distance or a distance of a few meters. The two sources 34 and 35 can be operated in phase or out of phase. When the sources 34 and 35 are operated in phase the sources 34 and 35 can create increased acoustic output.

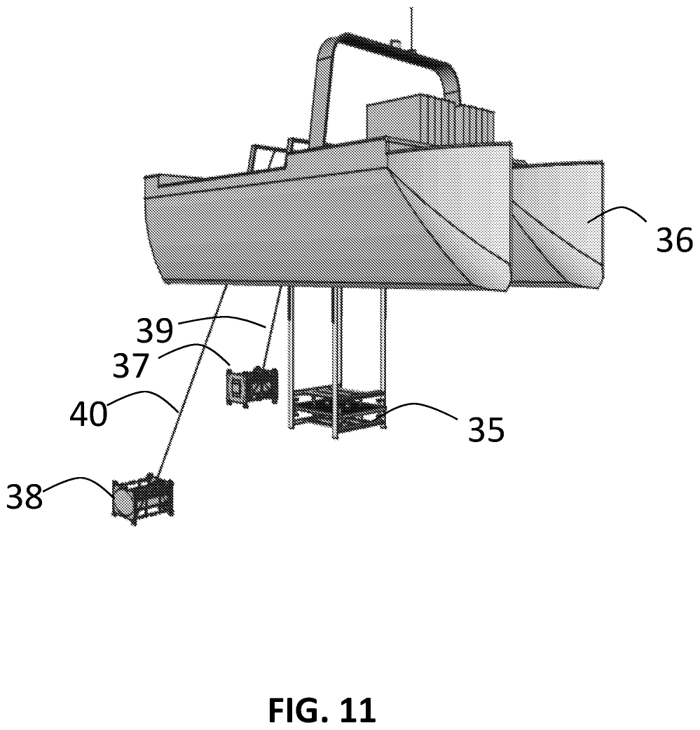

FIG. 11 shows a towing vessel 36 towing flex tensional sources 37 and 38 and with a fixed dipole source 35. The towing vessel 36 can be a catamaran which can be manually operated or autonomous. The sources 37 and 38 can be towed by umbilicals 39 and 40. The low frequency source 35 is attached to a fixed structure. The seismic sources 35, 37 and 38 can be activated to produce a down-going seismic wave that is at least partially reflected by a subsea interface or boundary. The up-going reflected seismic wave then travels towards sensors in a streamer or on the seabed.

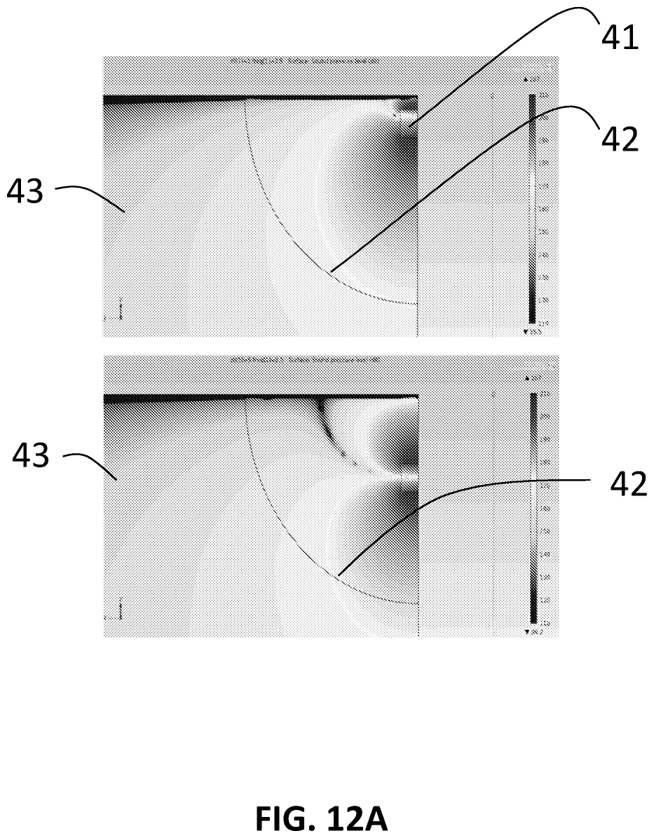

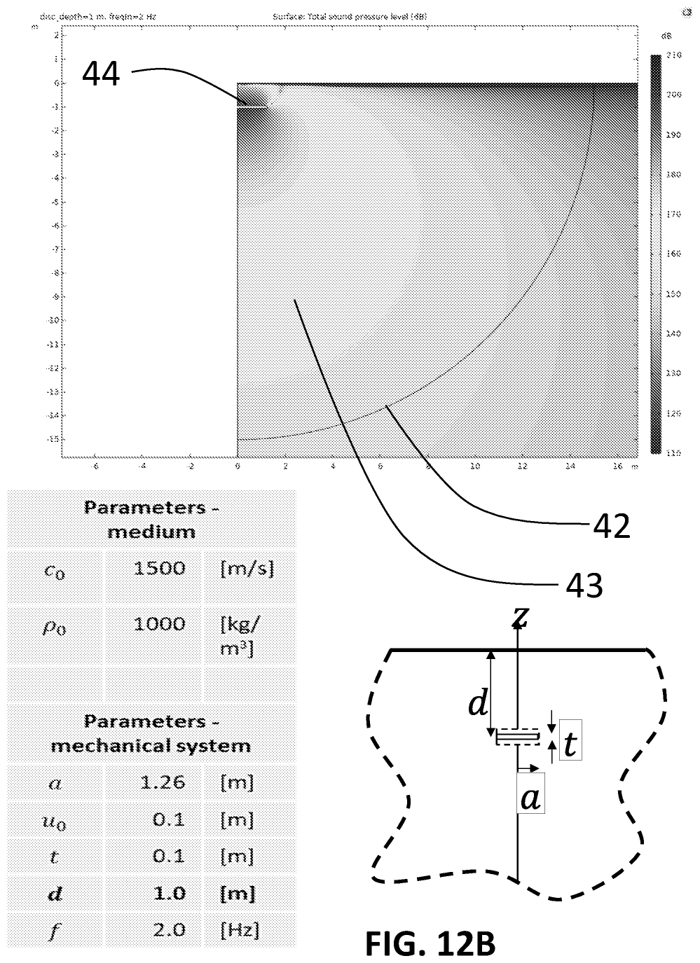

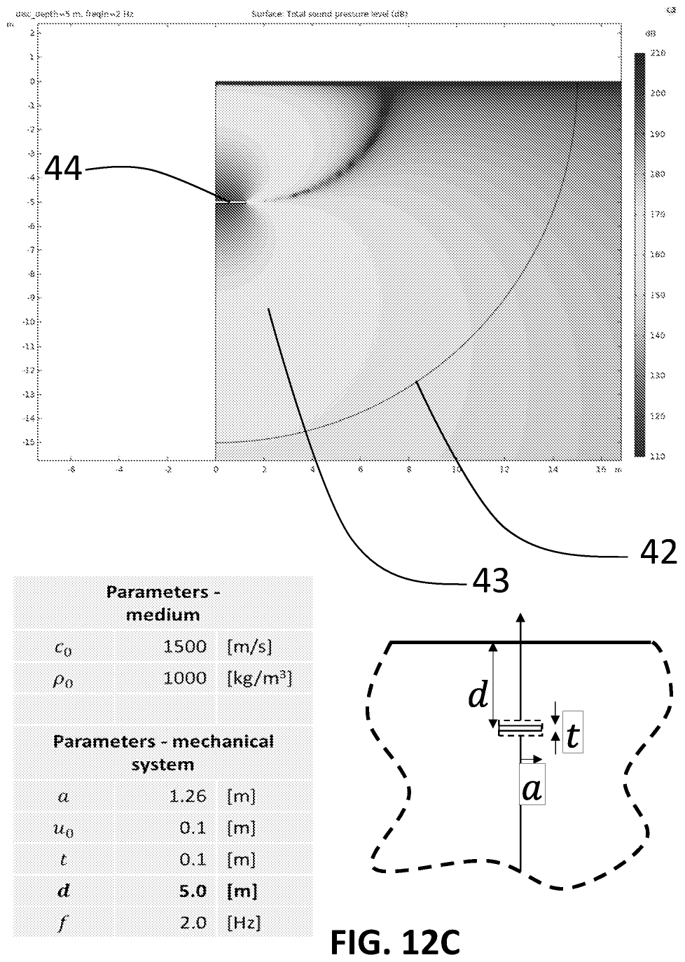

FIG. 12A shows a finite element simulation of the proposed source technology. The simulation was done with a ridged body 41 of 3 m×3 m×2 m moving +/−100 mm at 2.5 Hz in water at very shallow depths. Depth below water ranges from 1-5 m (from waterline to the top of the plate). Reflection from the surface causes sound radiated 43 from the top surface to change phase by 180 degrees and become in-phase with the energy from the lower surface. What is evaluated are the near-field and far-field behaviors of this type of source.

FIGS. 12B and 12C show the proposed source technology at a depth of 1 meter for FIG. 12B and at a depth of 5 meters for FIG. 12C. In these cases, the source is a plate 44 with the same surface area as for 12A.

The model is a dipole next to air/water interface using ¼ symmetry model, hemisphere of water with an infinite water domain. The air/water interface modeled as a “pressure-release” surface. Depth is changed from 1-5 m. Depth changes the near-field sound pattern. Black line 42 is located at 15 m. “Null” location is closer to the water surface at shallower depths.

At low frequencies and shallow depths, the water surface may not act like a pressure-release surface. A dipole source near the water surface has increased far-field output over a dipole source in “free space”. Near-field sound patterns have nulls in different locations. Very little change in far-field output SPL (directly below the source) as a function of source depth in the 1-5 m range. A dipole source near the surface may have a farfield SPL's 3.5-4.5 dB higher than a free-field dipole source for 1-5 m depths @ 2.5 Hz. A look at whether the air above the water influences the sound output shows that the far-field SPL is not affected, but near-field sound fields are affected. Simulation shows that monopoles and horizontally oriented dipoles are greatly influenced by the air domain.

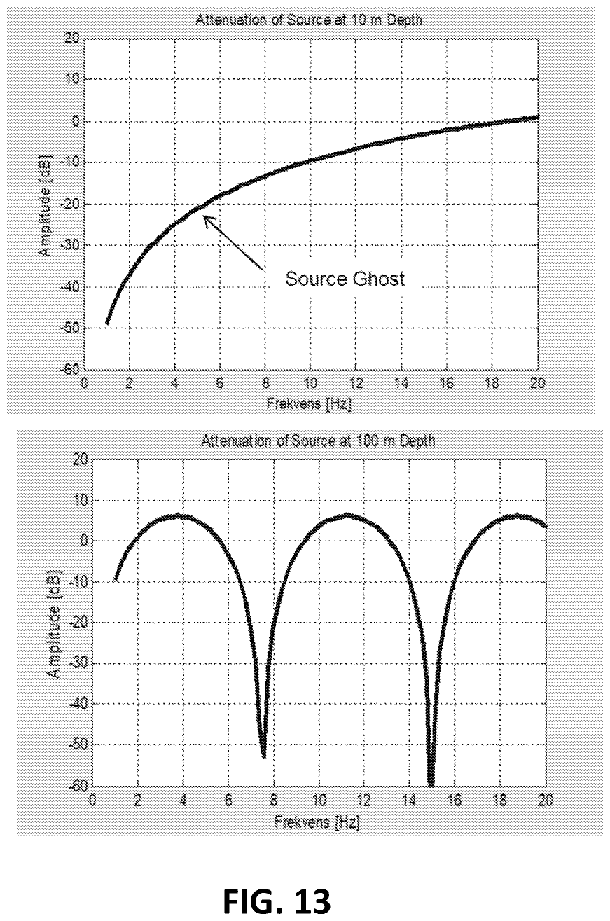

FIG. 13 shows the attenuation from the source ghost for an isotropic source. A reflection off the ocean surface can give rise to what is called a “ghost.” When an isotropic source is fired, a down going “source ghost” can combine with the wave initially radiated in the down-going direction. This combination of two down-going waves can modulate the source's amplitude spectrum by the amplitude of a sine function and results in the attenuation of low frequencies for the combined down-going wave and a reduction in the amount of information available in the seismic data. The figure shows the source ghost effect for an isotropic source at 10 m and 100 m depth with respect to frequency.

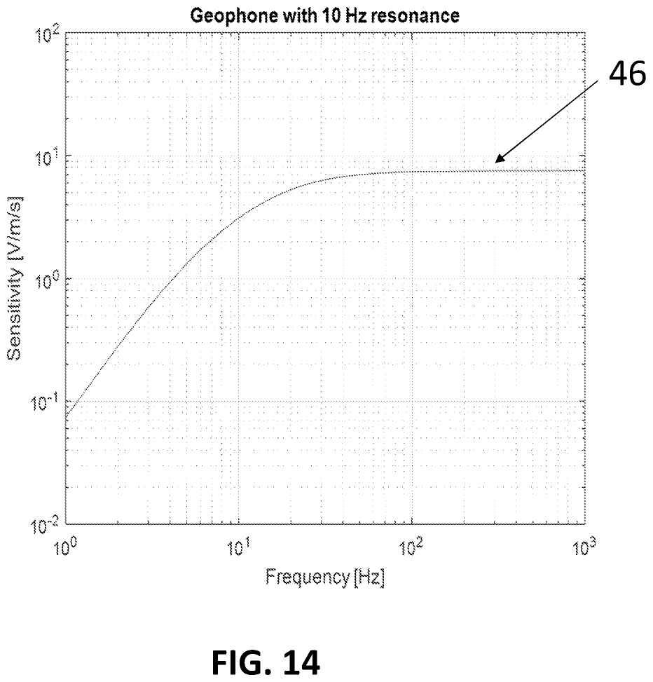

FIG. 14 shows the frequency response from a typical geophone 46. Since most motion sensors are based on a mass spring system the sensitivity will change with frequency. At 0 Hz the sensitivity is null. It then improves depending on where the resonance of the sensor is located. Results In this case the geophone has a resonance frequency of 10 Hz.

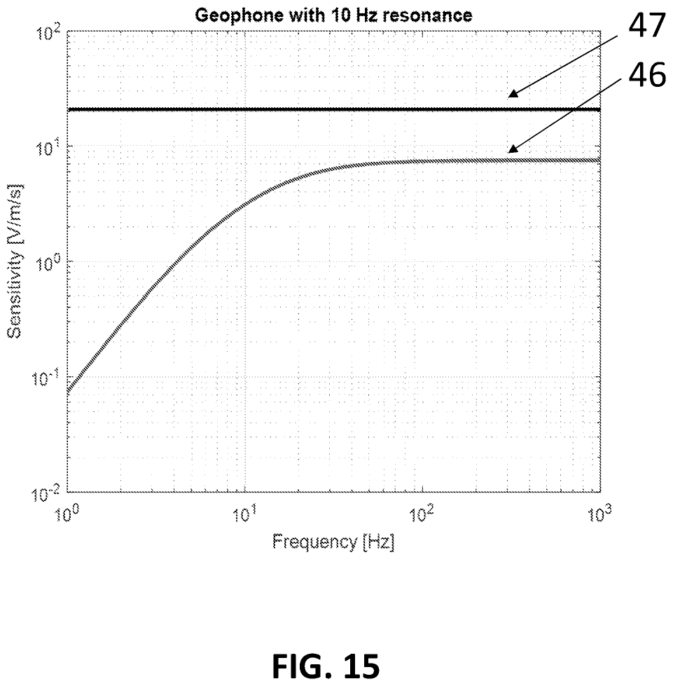

FIG. 15 shows the frequency response of a geophone 46 and the frequency response of a hydrophone 47. The geophone 46 can have a resonance at 10 Hz. The hydrophone can have a flat frequency response in the frequency band of interest. The sensor ghost can have the same effect on a pressure measurement as observed before the source ghost and attenuate the low frequencies. However, motion, measured by the geophone 46, is a vector quantity sensitive to direction and the measurement of the combined wave's motion can exhibit different behavior from that associated with the combined wave's pressure. The low frequencies associated with the combined wave's motion may be retained and enhanced. In theory, this would mean that a motion sensor would be preferred. Since most motion sensors are based on a mass spring system the sensitivity can change with frequency. At 0 Hz the sensitivity is null. It then improves depending on where the resonance of the sensor is located. Results from using a pressure sensor or a motion sensor, to detect low frequencies, can therefore be similar.

Systems and methods disclosed and claimed herein can be made and executed without undue experimentation in light of the present disclosure. While the systems and methods of this disclosure have been described in terms of various embodiments, it will be apparent to those of skill in the art that variations may be applied to the systems and methods and in the steps or in the sequence of steps of the methods described herein without departing from the concept, spirit, and scope of the disclosure.

1. A marine dipole source comprising:
a moveable plate connected to a surface vessel by a deployable structure;
one or more drivers configured to oscillate the moveable plate; and
one or more spring elements connected to the moveable plate configured to generate resonance in a frequency band of interest.

2. The marine dipole source of claim 1, wherein the one or more drivers comprises linear motors.

3. The marine dipole source of claim 1, wherein the one or more spring elements are adjustable to the frequency band of interest.

4. The marine dipole source of claim 1, wherein the deployable structure is configured to position the moveable plate 1-10 meters below a sea surface.

5. The marine dipole source of claim 4, wherein the deployable structure is of a streamlined form to reduce drag when towed.

6. The marine dipole source of claim 1, wherein the moveable plate vibrates at a frequency from 0.1-25 Hz.

7. The marine dipole source of claim 1, comprising a control system operable to control a frequency of the moveable plate, one or more drivers, and one or more spring elements.

8. A method of marine seismic surveying, the method comprising:
connecting a seismic dipole source to a surface vessel;
moving the surface vessel through a body of water over an undersea formation;
generating low frequency seismic signals by the seismic dipole source; and
receiving reflected low frequency seismic signals by a plurality of sensor streamers.

9. The method of claim 8, wherein the low frequency seismic signals are generated by moving a sound emitting surface by one or more linear motors and one or more spring elements.

10. The method of claim 8, wherein the low frequency seismic signals comprise a plurality of up-going waves and first down-going waves.

11. The method of claim 10, wherein the up-going waves are substantially 180 degrees out of phase of the first down going waves.

12. The method of claim 10, comprising reflecting the up-going waves off of a surface of the body of water resulting in second down-going waves.

13. The method of claim 12, comprising combining the first down-going wave and the second down-going wave in-phase resulting in a third down-going wave.

14. A marine seismic surveying system comprising:
a moveable surface vessel;
a marine dipole source connected to the moveable surface vessel;
a control system for the marine dipole source on the moveable surface vessel; and
at least one sensor configured to receive acoustic energy generated by the marine dipole source.

15. The system of claim 14, wherein the marine dipole source is positioned 1-10 meters below the moveable surface vessel.

16. The system of claim 14, wherein the control system is operable to control the marine dipole source such that the marine dipole source operates at resonance for all frequencies from 0.5 to 10 Hz.

17. The system of claim 14, comprising streamers spaced laterally apart from one another trailing behind the moveable surface vessel.

18. The system of claim 17, wherein each of the streamers comprise at least one sensor for generating response signals in response to the acoustic energy emitted from the dipole source after interaction with one or more subsurface formations.

19. The system of claim 14, wherein the at least one sensor is positioned on a solid marine surface.

20. The system of claim 14, wherein the moveable surface vessel is autonomous.
